(19) United States
(12) Patent Application Publication
(10) Pub. No.: US 2009/0213976 A1
(43) Pub. Date: Aug. 27, 2009

(54) Process for Production of Energy and Apparatus for Carrying Out the Same

(76) Inventors: Maria Chiara Gioscia, Roma (IT); Francesco Santasilia, Roma (IT)

Correspondence Address: LADAS & PARRY, 5670 WILSHIRE BOULEVARD, SUITE 2100, LOS ANGELES, CA, 90036-5679, US

(21) Appl. No.: 11/883,199

(22) PCT Filed: Jul. 8, 2005
(86) PCT No.: PCT/IT2005/000393

§ 371 Date: Mar. 19, 2008

(30) Foreign Application Priority Data
Feb. 3, 2005 (IT) RM2005A000047

(51) Int. Cl. G21B 1/05

(52) U.S. Cl. 376/133

(57) ABSTRACT

Process for energy production characterized by the generation of a positive concentric pulsating magnetic field by means of magnetic impulses convergent in only one point of the space, such to cause the temporary fusion of nuclei of hydrogen isotopes and their subsequent release; reactor for carrying out the process and apparatus containing said reactors.

The invention concerns a process for energy production and an apparatus for its realization. Particularly the invention concerns a reactor operating by means of pulsating concentric magnetic confinement of hydrogen isotopes.

Many nuclear fusion reactors are based on the principle that upon fusion (i.e. for magnetic confinement) of two hydrogen isotopes (i.e. deuterium and tritium), an Helium nucleus and a neutron are originated, both provided with high kinetic energy. The existing techniques, based on the hydrogen isotope complete fusion, show great operating and control difficulties. The machines realized are of considerable dimensions, need very high energies to trigger the nuclear fusion and are all at experimental stage. So the various magnetic confinement approaches, both at closed configuration (such as the Russian origin Tokamak, the american Stellarator, the German ASDEX Tokamak, the French TFR Tokamak, the American PLT Tokamak) and at open configuration (such as the “magnetic mirrors” structure, “convex field” structure, the “tandem configuration”, etc.), showed all to be highly complex and with great instability phenomena.

The most recent magnetic confinement experimental machines of great dimensions, such as the European JET, the American TFTR of Princeton, the Japanese JT60, the DIII-D in California and the Tora Supra in France, have obtained important results with regard to the magnetic confinement, but still for very limited times and with great obstacles to be overcame (power dissipated in the coils, presence of impurities in the plasma, etc.), as well as the necessity to invest very high capitals for their development and tuning (see the ITER joined project). Other techniques as the inertial confinement, both at direct and at indirect implosion, show also great obstacles to be overcome, as well as the necessity of very high investments.

The authors of the present invention have set up a semifusion process, namely a a temporary fusion, followed by release, between two hydrogen isotopes, equal or different from each other, i.e. deuterium and tritium, which, if conveniently brought nearer by means of convergent magnetic impulses in one point of the space, form an instable Helium nucleus, which splits (following the decrease of the magnetic impulse) in the original nuclei of the isotopes themselves.

The process releases a great amount of energy, much higher of the energy needed to create the pulsating magnetic field. The energy released, resulting from the conversion of a small mass amount of the nuclei involved in the semifusion process, is transformed from kinetic energy to thermal energy, then being conveniently used.

The authors have also designed an apparatus for the realization of the process. The apparatus includes essentially an external container wherein hard vacuum is made. A reactor is installed inside the container, wherein a positive pulsating magnetic field is obtained through separate magnetic impulses, all convergent in one point of the space. The reactor is equipped with convenient systems of thermal energy removal.

The process and the method of the invention find their application wherever an energy controlled production is requested.

Therefore it is an object of the instant invention a process for energy production characterized by the generation of a positive concentric pulsating magnetic field by means of magnetic impulses convergent in only one point of the space in presence of ionised water steam containing hydrogen isotopes, wherein said magnetic impulses are generated at a frequency and intensity such to cause the temporary fusion of nuclei of said hydrogen isotopes and their subsequent release. The hydrogen isotopes are preferably deuterium and/or tritium.

In one embodiment of the process of the invention, the energy in converted to thermal energy and conveniently removed and carried.

It is further object of the invention an airtight reactor consisting essentially of walls and of an inner chamber which is equipped with connections to a suction system in order to make hard vacuum inside, and means to supply demineralised water, optionally enriched with hydrogen isotopes; of electrical connectors connected to electromagnets inserted perpendicularly and airtight in said reactor walls, wherein the electromagnets are directed towards the center of the inner chamber such that the positive sign tips of each electromagnet are all disposed at the same distance from the central point of the inner chamber, defining an ideal sphere. The reactor is preferably of spherical shape and the electromagnets are radially inserted in the wall of the reactor itself, such that the positive sign tips form a perfect ideal sphere, whose center matches with the center of the reactor itself.

A further object of the invention is an apparatus for the temporary fusion and subsequent release of hydrogen isotope nuclei including:

a) a container equipped with tight closure means containing inside at least a reactor according to the invention;

b) thermal energy removal means;

c) a rectifier of current coming from the electric system, having a capacity able to feed at the same time all of the electromagnets;

d) means which are able to modulate and distribute the electrical impulses to the electromagnets, able to ensure a fine tuning of the electromagnets themselves and therefore a high positive pulsating magnetic field inside the inner chamber of the reactor, allowing the trigger and the maintenance of the temporary fusion and the subsequent release of the hydrogen isotope nuclei.

Preferably the reactor of the apparatus is equipped with double walls which delimit a second chamber which encloses the inner chamber and which contains a circulating cooling fluid for the thermal energy removal. Such second chamber is not in communication with the reactor inner chamber nor with the inner space of the container. In an alternative embodiment, in the apparatus for the temporary fusion and subsequent release of the hydrogen isotope nuclei the at least one reactor is contained in a tight vessel wherein said means of thermal energy removal circulate. The expert in the field will understand that the number of reactors in the apparatus may vary and all of these embodiments is within the scope of the invention.

The reactor and the apparatus will now be described according to particular embodiments, not limitating the scope of protection of the invention, with reference to the enclosed figures:

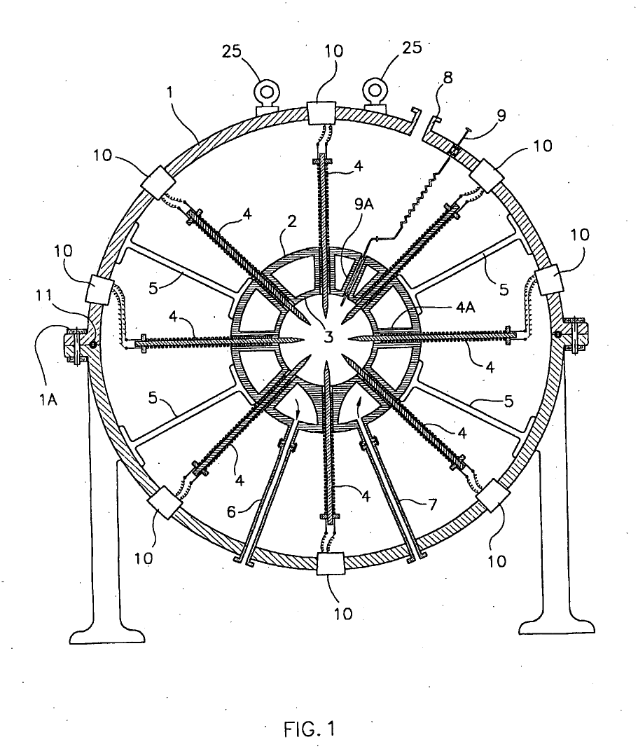

FIG. 1 represents a view in vertical section of an embodiment of the reactor according to the invention.

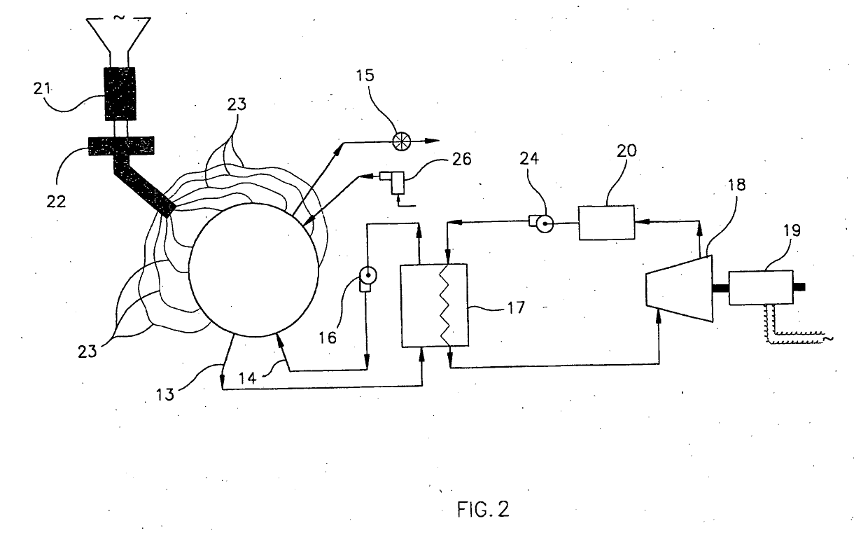

FIG. 2 represents a diagram of an electric energy production system using the energy produced by the reactor according to FIG. 1.

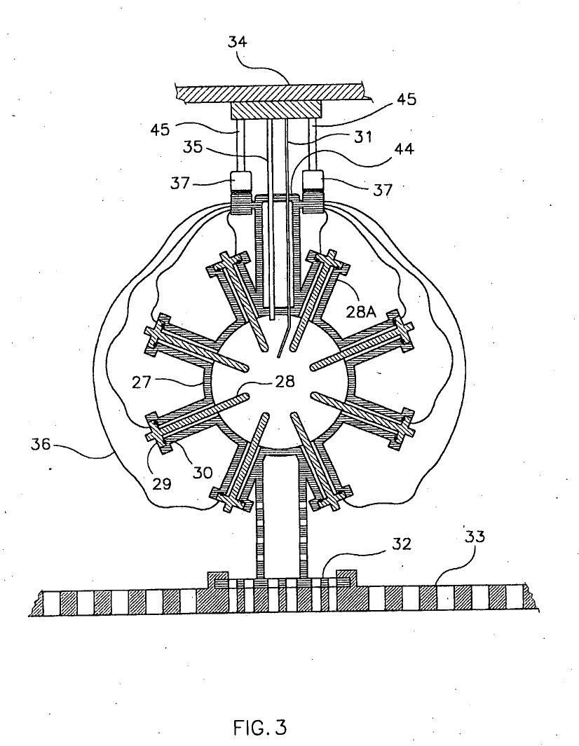

FIG. 3 represents a view in vertical section of a further embodiment of the reactor according to the invention.

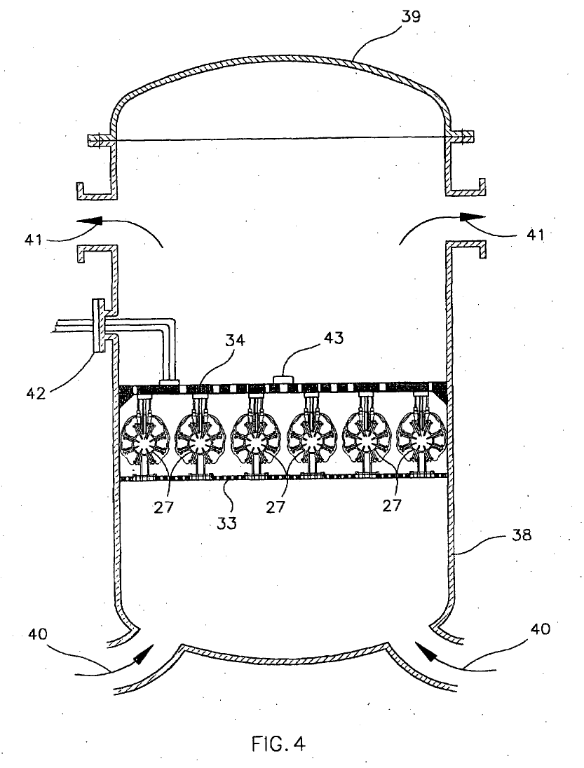

FIG. 4 represents a view in vertical section of a cylindrical vessel containing more reactors of the embodiment of FIG. 3.

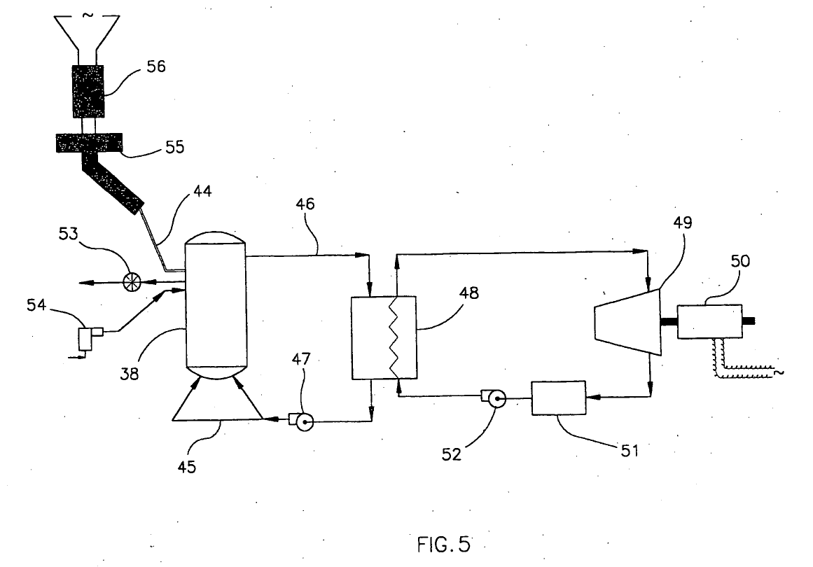

FIG. 5 represents a diagram of an electrical energy production system using the energy produced by the reactors according to FIGS. 3 and 4.

With reference to FIG. 1 the apparatus consists of a spherical container 1 of the nuclear reactor, made of two semispherical caps connected together by means of peripheral bolts la along the horizontal circumference, and of an O-ring 11 to ensure the forming of hard vacuum inside the container itself.

The container 1 is supported by foots anchored to the lower cap. The upper cap is equipped on the top with hooks 25 to permit its unloading and thus the opening and closure of the spherical container 1. Inside the container 1 a spherical body is installed made up of an external spherical chamber 2 and an inner chamber 3 connected together by means of passing through tubes 4a which are directed towards the center of the inner chamber 3. The interspace between the two spherical chambers 2 and 3 is fully separated and isolated from the inner space of the central sphere 3 and the spherical container 1.

The whole spherical body inside the container 1 is hold in position by support spacers 5 anchored to the wall of the spherical chamber 2. Radially to the inner spherical body, and all directed towards the center of the sphere 3, are anchored more electromagnets 4, equidistant along the spherical body circumferences. They pass through the tubular housing 4a which connect the spherical chamber 2 with the inner chamber 3. Therefore the positive sign tips of the electromagnets 4 are all disposed at the same distance from the center of chamber 3, defining an ideal sphere. Each electromagnet 4 is equipped with a micrometer adjustment device of the positive sign tip, so to ensure that all tips are at same distance from the center of chamber 3. Each winding of each electromagnet 4 is electrically connected to its connector 10, fixed in an airtight slot in the spherical wall of the container 1, through extensible electrical cables so to permit the opening of the upper cap of the container 1. Since the space of the spherical container 1 is communicating with the space of the spherical chamber 3, the hard vacuum is made in both the environments by means of the connection 8.

Through the inlet pipe 7 and outlet pipe 8, inside the interspace between chamber 2 and chamber 3, and therefore around the spherical chamber 3, a cooling fluid circulates and then removes the thermal energy produced inside the spherical chamber 3 itself due to the nuclear reaction. The pipe 9 which pass through the spherical wall of the container 1 with airtight seals, and by means of a tubular housing 9a through the spherical chamber 2, supplies the reaction chamber 3 with demineralised water, eventually enriched with hydrogen isotopes, needed for the nuclear semifusion. Such pipe 9 is extensible so to permit the opening of the upper cap of the container 1.

FIG. 2 represents a diagram of an electrical power plant. A simple sphere in section 12 represents the whole nuclear semifusion reactor, according to the FIG. 1. The cooling fluid outlet piping 13 is directed with the recirculation pump 16 (through the connection with the pipe 6 shown in FIG. 1), from the reactor to a steam producing heat exchanger 17. From the latter the cooling fluid goes back to the reactor through the piping 14 connected to the pipe 7 of FIG. 1. The steam produced is directed to the turbine 18 connected with the electric generator 19. The exhausted steam which comes out from the turbine, is condensed in the condenser 20 and the condensed water is recirculated to the steam producer 17 by means of the pump 24. The vacuum pump 15 makes the hard vacuum inside the spherical container 1 through the connection 8 of FIG. 1.

The metering pump 26, through the pipe 9 of FIG. 1, feeds the reactor with demineralised water (eventually enriched with hydrogen isotopes) needed for the nuclear semifusion.

The electromagnets 4 of FIG. 1 are electrically connected, through the connectors 10 of FIG. 1, to the electric cables 23 which in their turn are connected to the modulator and distributor of electrical impulses 22 in direct current. The cables 23 are connected to the electromagnets 4 so that the magnetic field is positive in the direction of the reaction sphere chamber 3 center. The impulse modulator/distributor 22 is fed by the current rectifier 21 which in its turn is fed by the current coming from the electric system. The modulator/distributor 22, by means of convenient measurement instruments and control devices, ensures at any moment the equality of the pulsating magnetic field intensity produced by each electromagnet 4, therefore compensating the unavoidable manufacturing tolerances of the electromagnets 4 themselves. In other terms the modulator/distributor 22 provides the tuning of all the electromagnets 4 in order to maximize the pulsating magnetic field at the center of the reaction spherical chamber 3 and favour the semifusion of the hydrogen isotope nuclei present in the ionised steam. Convenient measurement instruments and control devices, omitted for representation simplicity (temperature inside the reaction chamber 3, temperature of the cooling fluid, flow of the water feeding the nuclear semifusion, temperature of the spherical bodies, magnetic field intensity, etc.), provide, through the modulator/distributor 22, the control of the magnetic impulse frequencies and intensities in order to control the energy produced by the nuclear reactor.

A further embodiment, reproduced in FIG. 3, is realized with a spherical reaction chamber 27. Radially to the spherical reaction chamber 27, and all directed towards the center of the chamber itself, are anchored the electromagnets 28 equidistant along the spherical reaction chamber 27 circumferences. The positive sign tips of all the electromagnets 28 are disposed at same distance from the center of the spherical reaction chamber 27, defining an ideal sphere. Each electromagnet 28 is equipped with a micrometer adjustment device of the positive sign tips, so to ensure that all tips are at the same distance from the center of the spherical chamber 27. The electromagnets 28 pass through the tubular housings 28a welded on the reaction chamber 27 and with their cap 29, screwed at the top of the tubular housings 28a themselves, ensure the perfect tightness of the spherical reaction chamber 27, also by means of O-rings 30. Therefore it is possible to make the hard vacuum inside the spherical reaction chamber 27 through the extraction pipe 35. The windings of the electromagnets 28 are electrically connected, by means of the electrical cables 36 to the connectors 37 which ensure the electrical connection with the outside. With reference to FIGS. 3 and 4, each reaction chamber 27 is equipped with an inlet pipe 31 which feeds the reaction chamber itself with demineralised water (eventually enriched with hydrogen isotopes), needed for the nuclear semifusion. Each spherical reaction chamber 27 is equipped at the bottom with an outside block 32 which connects itself with a bayonet joint to the support plate 33 reproduced in FIGS. 3 and 4. Each spherical reaction chamber 27 can be removed from, and reassembled to, the support plate 33 by means of the upper handle 44 integral with the spherical chamber 27 itself. The inflow pipe 31 of demineralised water (eventually enriched with hydrogen isotopes), the extraction pipe 35 for the hard vacuum and the tubes 45 carrying the electrical cables connected to the electromagnets 28, converge all to the removable plate 34.

In more details, FIG. 4 represents in very schematic way an apparatus of an embodiment of the invention, which includes a high pressure resistant cylindrical vessel 38 equipped inside with an horizontal fixed plate 33 supporting all of spherical reaction chambers 27. The fixed plate 33 has circular openings over its whole surface to permit the upward flow of the cooling fluid which laps on all the spherical reaction chambers 27 thus removing the thermal energy produced by the reaction chambers themselves by means of the nuclear semifusion. The plate 34, placed above the spherical reaction chambers 27, is also provided with openings to permit the upward flow of the cooling fluid and can be removed by means of the hook 43 so to permit the removal and installation of the spherical reaction chambers 27 in order to make their possible maintenance or replacement. This plate 34 assembles on itself all the pipes 31, 35 and 45, represented in FIG. 3, of all the spherical reaction chambers 27, and channels them outside the cylindrical vessel 38 through the fluidtight flange. The pressurized cooling fluid gets into the cylindrical vessel 38 through the inlets 40 and gets out through the outlets 41. The cylindrincal vessel 38 is equipped on the top with a removable cap 39 to permit the access to its interiors.

FIG. 5 represents schematically a diagram of the electrical power plant of the reactors according to the embodiments of the FIGS. 3 and 4. A simple cylinder in section 38 represents the whole reactor. The cooling fluid outlet piping 46 is directed with the recirculation pump 47 (through the connection with the outlets 41 shown in FIG. 4), from the reactor to a steam producing heat exchanger 48. From the latter the cooling fluid goes back to the reactor through the piping 45 connected to the inlet 40 of FIG. 4. The steam produced is directed to the turbine 49 connected with the electric generator 50. The exhausted steam which comes out from the turbine, is condensed in the condenser 51 and the condensed water is recirculated to the steam producer 48 by means of the pump 52. The vacuum pump 53 makes the hard vacuum inside all the spherical reaction chambers 27 through the connection with the tubes 31 of FIG. 3. The metering pump 54, connected to all the pipes 35 of the FIG. 3, feeds all spherical reaction chambers 27 with demineralised water (eventually enriched with hydrogen isotopes) needed for the nuclear semifusion.

The electromagnets 28 of FIG. 3 are electrically connected, through the connectors 37 of FIG. 3, through the carrying tubes 45, through the flange 42 of the FIG. 4 and through the carrying tube 44 of the FIG. 5, to the modulator and distributor of electrical impulses 55 in direct current. The electromagnets 28 are fed so that the magnetic field is positive in the direction of the center of each of the reaction chambers 27. The impulse modulator/distributor 55 is fed by the current rectifier 56 which in its turn is fed by the current coming from the electric system. The modulator/distributor 55, by means of convenient measurement instruments and control devices, ensures at any moment the equality of the pulsating magnetic field intensity produced by each electromagnet 28, therefore compensating the unavoidable manufacturing tolerances of the electromagnets 28 themselves. In other terms the modulator/distributor 55 provides the tuning of all the electromagnets 28 of each spherical reaction chamber 27 in order to maximize the pulsating magnetic field at the center of each of the reaction spherical chamber 27 and favour the semifusion of the hydrogen isotope nuclei present in the ionised steam.

Convenient measurement instruments and control devices, omitted for representation simplicity (temperature inside the reaction chambers 27, temperature of the cooling fluid, flow of the water feeding the nuclear semifusion, temperature of the spherical bodies of the reaction chambers 27, magnetic field intensity, etc.), provide, through the modulator/distributor 55, the control of the magnetic impulse frequencies and intensities in order to control the energy produced by the nuclear reactor.

1. Process for energy production characterized by the generation of a positive concentric pulsating magnetic field by means of magnetic impulses convergent in only one point of the space, in the presence of ionised water steam containing hydrogen isotopes, wherein said magnetic impulses are generated at a frequency and intensity such to cause the temporary fusion of the nuclei of said hydrogen isotopes and their subsequent release.

2. Process for energy production according to claim 1 wherein the hydrogen isotopes are deuterium and/or tritium.

3. Process for energy production according to claim 1 wherein the energy is converted to thermal energy and conveniently removed and carried.

4. Airtight reactor consisting essentially of walls and of an inner chamber which is equipped with connections to a suction system in order to make hard vacuum inside, and with feeding means of demineralised water, optionally enriched with hydrogen isotopes; with electrical connectors connected to electromagnets inserted perpendicularly and airtight in said reactor walls, wherein the electromagnets are directed towards the center of the inner chamber so that the positive sign tips of the electromagnets are all disposed at the same distance from the central point of said inner chamber, defining an ideal sphere.

5. The reactor according to claim 4 having an essentially spherical shape and wherein electromagnets are radially inserted in the wall of the reactor, so that the positive sign tips form a perfect ideal sphere, whose center matches with the center of the reactor itself.

6. Apparatus for the temporary fusion and subsequent release of the hydrogen isotope nuclei including:
a) a container equipped with tight closure means containing inside at least a reactor according to claim 4;
b) means of thermal energy removal;
c) a rectifier of current coming from the electric system, having a capacity such to feed at the same time all the electromagnets;
d) means able to modulate and distribute the electrical impulses between the electromagnets, capable to insure a fine tuning of the electromagnets themselves and therefore a high positive pulsating magnetic field inside the inner chamber of the reactor, allowing the trigger and maintenance of the temporary fusion and subsequent release of the hydrogen nuclei.

7. Apparatus for the temporary fusion and subsequent release of the hydrogen isotope nuclei according to claim 6 wherein the reactor is equipped with double walls which delimit a second chamber which encloses the inner chamber and inside which circulates a cooling fluid for the thermal energy removal, wherein said second chamber does not communicate with the reactor inner chambers nor with the inner space of the container.

8. Apparatus for the temporary fusion and subsequent release of the hydrogen isotope nuclei according to claim 6 wherein the at least one reactor is contained in a tight vessel wherein said means of thermal energy removal circulate.
